(19) United States
(12) Patent Application Publication
(10) Pub. No.: US 2015/0099030 A1
(43) Pub. Date: Apr. 9, 2015

(54) DIE CLAMPING APPARATUS OF INJECTION MOLDING MACHINE WITH PLATEN ADJUSTMENT MECHANISM

(71) Applicant: FANUC Corporation, Yamanashi (JP)

(72) Inventor: Hiroaki KIRIHATA, Yamanashi (JP)

(21) Appl. No.: 14/505,573

(22) Filed: Oct. 3, 2014

(30) Foreign Application Priority Data
Oct. 4, 2013 (JP) 2013-209062

(51) Int. Cl. B29C 45/17

(52) U.S. Cl. CPC B29C 45/1761; B29C 45/1744
USPC 425/589

(57) ABSTRACT

A bracket is disposed on both side surfaces of both ends of each of a rear platen side rail and a movable platen side rail. The bracket includes a screw hole. When an adjustment bolt is tightened, the adjustment bolt presses the rear platen side rail or the movable platen side rail. A rear platen and a movable platen are aligned to each other by finely adjusting the directions of the rear platen side rail and the movable platen side rail.

### BACKGROUND OF THE INVENTION

1. Field of the Invention

The present invention relates to a die clamping apparatus which guides a movable platen and a rear platen of a die clamping apparatus by a linear guide device in an injection molding machine.

2. Description of the Related Art

When a die clamping force is generated by closing a die, a movable platen moves along a tie-bar toward a fixed platen, and a rear platen moves in a direction opposite to the fixed platen in response to the extension of the tie-bar caused by the extension of a toggle mechanism. At this time, when a deviation occurs in the movable platen or the rear platen in a direction perpendicular to the tie-bar, a misalignment occurs between a fixed side and a movable side in the die.

For that reason, there is a need to suppress the deviation of the movable platen with respect to the fixed platen and the deviation of the rear platen with respect to the fixed platen particularly in a precise molding process.

In JP-A 9-262884, a movable platen and a rear platen are guided along a ball type linear guide, and the movable platen is fixed to an eccentric shaft or a block of the linear guide. In JP-A 2009-269393, a movable platen and a rear platen are guided along a linear guide, and a connection member provided between the rear platen and a block of the linear guide is fixed to the center position of the rear platen. Further, in JP-A 2000-246774, a portion equipped with the linear guide supporting the rear platen and the movable platen is formed so as to be easily bent in the lateral direction.

Due to a difference in dimension of a platen or a component of a toggle link, it is difficult to mention that the movable platen and the rear platen have the same straight advancing characteristic. For that reason, when the movable platen and the rear platen are provided on the same linear guide as in the related art, the movable platen and the rear platen do not have a satisfactory straight advancing characteristic, and hence a die clamping precision may be adversely affected.

In the apparatus disclosed in JP-A 9-262884, the eccentric shaft provided below the movable platen is used to adjust the alignment by moving the movable platen in the up and down directions. However, since the movable platen and the rear platen are provided in the common linear guide, the alignment may not be performed with high precision.

The apparatus disclosed in JP-A 2009-269393 is used to reduce a load of the guide device by suppressing an influence of a deformation caused by the rear platen.

In the apparatus disclosed in JP-A 2000-246774, the rear platen and the movable platen are supported by different linear guides. However, the straight advancing characteristics of the movable platen and the rear platen may not be adjusted without using the linear guide adjustment mechanism.

### SUMMARY OF THE INVENTION

Therefore, an object of the invention is to provide a die clamping apparatus of an injection molding machine with a platen adjustment mechanism capable of adjusting the relative position between a rear platen and a fixed platen of a movable platen with high precision and of improving the straight advancing characteristics of the movable platen and the rear platen by providing a mechanism for adjusting the direction of a rail of a linear guide.

According to the invention, there is provided a die clamping apparatus of an injection molding machine including abase, a rear platen, a movable platen, a pair of movable platen linear guides configured to guide the movable platen, and a pair of rear platen linear guides different from the movable platen linear guide and configured to guide the rear platen, the die clamping apparatus of the injection molding machine including at least one of: a movable platen linear guide adjustment mechanism configured to adjust the position of a rail disposed on a top surface of the base of the movable platen linear guides in a direction parallel to the top surface of the base; and a rear platen linear guide adjustment mechanism configured to adjust the position of a rail disposed on the top surface of the base of the rear platen linear guides in a direction parallel to the top surface of the base.

Since the invention has the above-described configuration, the movable platen and the rear platen are provided on separate linear guides and the mechanism adjusting the position of at least one linear guide is provided. Accordingly, it is possible to perform an adjustment for solving a difference in dimension of a component such as a toggle link of a die clamping apparatus, and hence to improve the straight advancing characteristics of the movable platen and the rear platen.

### BRIEF DESCRIPTION OF THE DRAWINGS

The above-described object, the other object, and the feature of the invention will be proved from the description of embodiments below with reference to the accompanying drawings. In these drawings:

FIG. 1 is a side view illustrating a die clamping mechanism when a die is opened;

FIG. 2 is a side view illustrating the die clamping mechanism when a die is clamped;

FIG. 3 is a top view illustrating a guide which is not adjusted yet;

FIG. 4 is a view taken along the line A-A of FIG. 3;

FIG. 5 is a top view illustrating the adjusted guide; and

FIG. 6 is a view taken along the line A-A of FIG. 5.

### DETAILED DESCRIPTION OF THE PREFERRED EMBODIMENTS

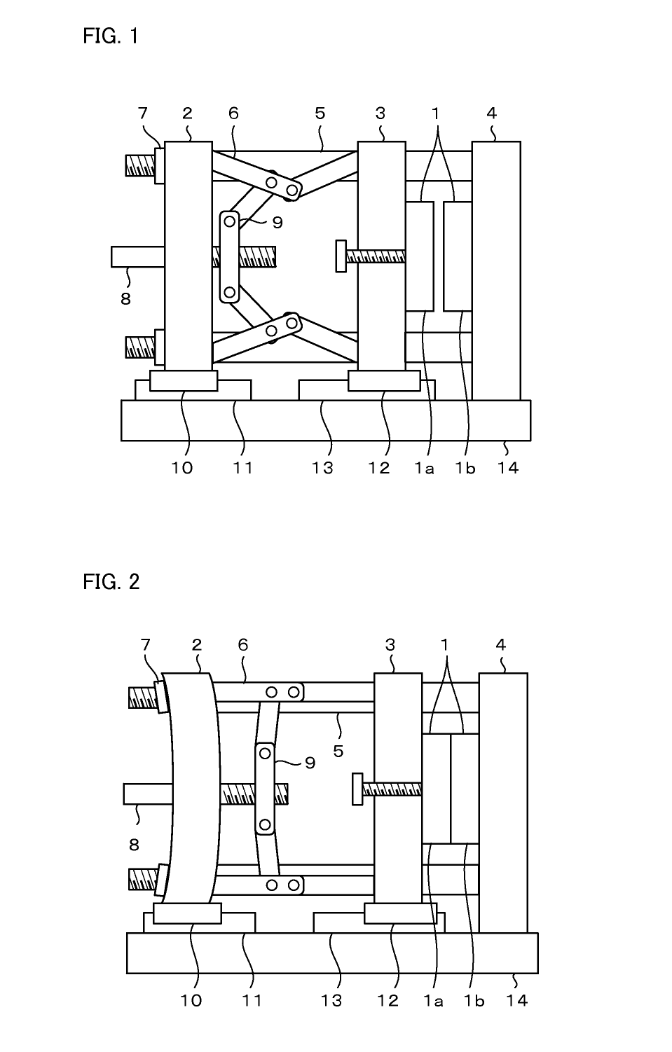

FIG. 1 is a view illustrating a die clamping mechanism of an injection molding machine. The die clamping mechanism which is disposed on abase 14 includes a movable platen 3 which is equipped with a movable die la in a die 1, a fixed platen 4 which is equipped with a fixed die lb in the die 1, a rear platen 2, a tie-bar 5, a toggle mechanism 6, a tie-bar fixing nut 7, a cross head 9, and the like.

The rear platen 2 and the fixed platen 4 are connected to each other by the plurality of tie-bars 5, and the movable platen 3 is disposed so as to be guided along the tie-bars 5. However, the movable platen 3 may not be guided by the tie-bars 5. The rear platen 2 is fixed to a rear platen side guide block 10 which is guided by a rear platen side rail 11, and the movable platen 3 is fixed to a movable platen side guide block 12 which is guided by a movable platen side rail 13. The rear platen side rail 11 and the movable platen side rail 13 are fixed to the base 14, respectively. Furthermore, the rear platen side guide block 10 and the rear platen side rail 11 constitute a rear platen linear guide. Further, the movable platen side guide block 12 and the movable platen side rail 13 constitute a movable platen linear guide.

Next, the die clamping mechanism when the die is clamped will be described with reference to FIG. 2. A ball screw shaft 8 is driven by a servomotor (not shown). The toggle mechanism 6 is operated in a manner such that the cross head 9 attached to the ball screw shaft 8 moves in a reciprocating manner. When the cross head 9 advances toward the fixed platen, the movable platen 3 advances so that the die is clamped. At this time, a die clamping force which is obtained by multiplying a toggle magnification by a thrust force generated by a servo motor (not shown) is exerted. The die is clamped by the die clamping force. At this time, a tensile force corresponding to the die clamping force generated when the die is clamped is applied to the tie-bars 5, and the tie-bars are slightly extended in proportional to the die clamping force. Since the tie-bars 5 are fixed to the rear platen 2, the rear platen 2 is curved by the extension of the tie-bars, and the rear platen side guide block 10 moves in a direction opposite to the fixed die 1b.

When an injection molding process in the die 1 ends in a die clamping state, the die is opened. The ball screw shaft 8 is rotated in a direction opposite to a direction in which the die is clamped. Accordingly, the cross head 9 retreats, the toggle mechanism 6 is operated in a curve direction, and the movable platen 3 retreats toward the rear platen 2. The deformation of the rear platen 2 disappears when the extension of the tie-bars is cancelled, and the rear platen side guide block 10 moves up to an original position.

In the above-described molding cycle, the rear platen side guide block 10 and the rear platen 2 fixed thereto move in a reciprocating manner on the rear platen side rail 11. There is a need to fix the rear platen side rail 11 and the movable platen side rail 13 so that the rear platen 2 and the movable platen 3 are not misaligned from each other.

The rear platen side rail 11 and the movable platen side rail 13 do not need to be arranged on a straight line, and may be arranged in parallel to each other. However, both rails may not be parallel to each other as a result of the adjustment. When the directions of the rear platen side rail 11 and the movable platen side rail 13 arranged in parallel to each other are finely adjusted, the rear platen 2 and the movable platen 3 can be highly precisely aligned to each other.

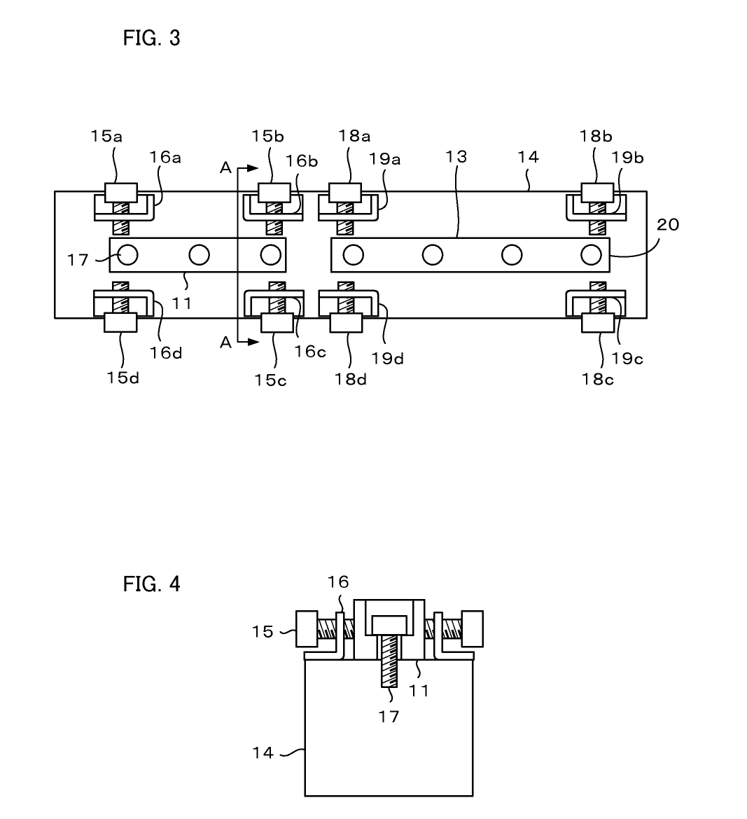

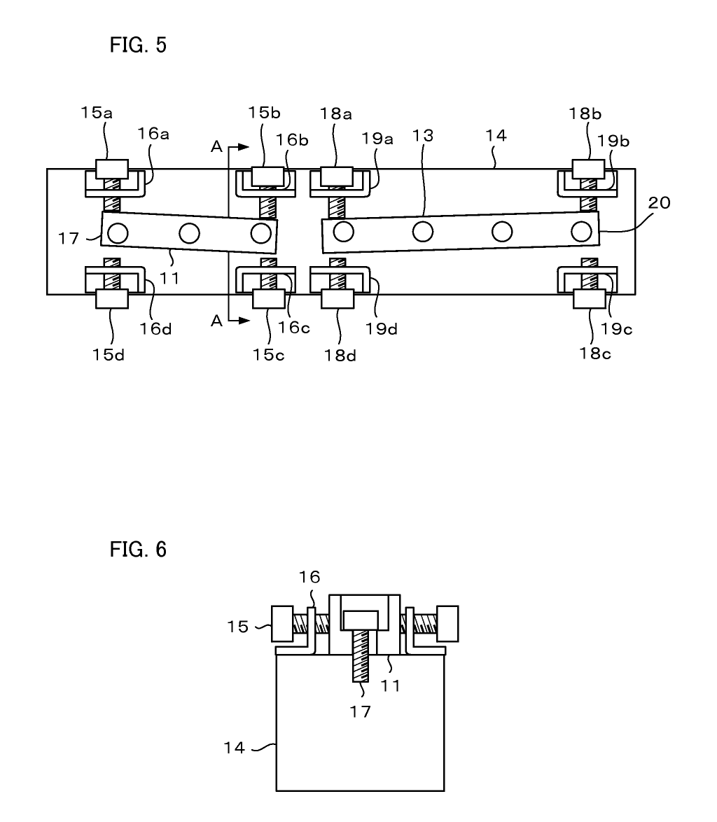

As an example, FIG. 3 illustrates a mechanism which adjusts the positions of the rails, that is, the rear platen side rail 11 and the movable platen side rail 13 in the horizontal direction by pressing both ends of the rails using screws. A bracket 16 is disposed on both side surfaces of the rear platen side rail 11 and the movable platen side rail 13, and is fixed to the base 14. Here, the bracket 16 indicates brackets 16a, 16b, 16c, and 16d. The bracket 16 includes a screw hole. As an adjustment bolt 15 is tightened, the adjustment bolt 15 protrudes toward the rail so that the rail can be pressed. Here, the adjustment bolt 15 indicates adjustment bolts 15a, 15b, 15c, and 15d. In FIG. 5, the rear platen side rail 11 and the movable platen side rail 13 are rotated in different directions by tightening the right upper adjustment bolt 15b of the rear platen side rail 11 and the left upper adjustment bolt 18a of the movable platen side rail 13. In this way, as the positions of both ends of the rails, that is, the positions are changed in a direction parallel to the top surface of the base 14, the directions of the rails can be also changed. Here, Reference Numerals 18a, 18b, 18c, and 18d indicate the adjustment bolts, and Reference Numerals 19a, 19b, 19c, and 19d indicate the brackets.

As shown in FIG. 4, the rear platen side rail 11 and the movable platen side rail 13 are respectively fixed by guide bolts 17 and 20, but a gap exists between the rear platen side rail 11 and the guide bolt 17. In the range of the gap, the positions of the rails can be finely adjusted by pressing the rails using the adjustment bolt 15 as shown in FIG. 6. Further, only a rear platen linear guide adjustment mechanism which adjusts the position of the rear platen side rail 11 may be provided, only a movable platen linear guide adjustment mechanism which adjusts the position of the movable platen side rail 13 may be provided, or both of them may be provided as in the example shown in FIGS. 3 to 6.

The rear platen side guide block 10 and the movable platen side guide block 12 may be provided at a plurality of positions. Further, a connection block (not shown) may be provided between the rear platen side guide block 10 and the rear platen 2. Similarly, a connection block (not shown) may be provided between the movable platen side guide block 12 and the movable platen 3. Further, since the guide and the rail may guide a target by a roller or a ball, an optimal linear guide can be selected in accordance with the positional precision necessary for each of the rear platen side guide block 10 and the movable platen side guide block 12.

1. A die clamping apparatus of an injection molding machine including a base, a rear platen, a movable platen, a pair of movable platen linear guides configured to guide the movable platen, and a pair of rear platen linear guides different from the movable platen linear guides and configured to guide the rear platen, the die clamping apparatus of the injection molding machine comprising at least one of:
a movable platen linear guide adjustment mechanism configured to adjust the position of a rail disposed on a top surface of the base of the movable platen linear guides in a direction parallel to the top surface of the base; and
a rear platen linear guide adjustment mechanism configured to adjust the position of a rail disposed on the top surface of the base of the rear platen linear guides in a direction parallel to the top surface of the base.
